(19) United States
(12) Patent Application Publication
(10) Pub. No.: US 2024/0318465 A1
(43) Pub. Date: Sep. 26, 2024

(54) Safety Gate Monitoring Module

(71) Applicant: Pilz GmbH & Co. KG, Ostfildern (DE)

(72) Inventors: Joachim Rink, Ostfildern (DE); Andreas Veit, Ostfildern (DE)

(21) Appl. No.: 18/590,416

(22) Filed: Feb. 28, 2024

(30) Foreign Application Priority Data
Feb. 28, 2023 (DE) 102023104853.8

(51) Int. Cl. E05B 47/00; E06B 9/00

(52) U.S. Cl. CPC E05B 47/0046; E05B 2047/0068; E06B 2009/002

(57) ABSTRACT

A safety gate monitoring module for monitoring a state of a safety gate includes an actuator receptacle. The actuator receptacle receives an actuator and is configured to produce a safety gate signal when the actuator is inserted into the actuator receptacle. The actuator receptacle includes a guard lock device that is configured to hold the actuator firmly in the actuator receptacle in an activated state. The guard lock device includes a bolt having a bearing element receptacle and a bearing element rotatably mounted in the bearing element receptacle and arranged at a free end of the bolt. The free end of the bolt engages with the actuator in order to lock the actuator in the actuator receptacle in the activated state.

### CROSS-REFERENCE TO RELATED APPLICATIONS

This application claims priority to German App. No. DE 10 2023 104 853.8 filed Feb. 28, 2023, the entire disclosure of which is incorporated by reference.

### FIELD

The present disclosure relates to safety-related protective devices and more particularly to control of a separating protective device.

### BACKGROUND

Safety gate monitoring modules are often referred to as safety switches. Illustrative safety gate monitoring modules or safety switches of the type mentioned at the outset are known from DE 10 2005 057 108 A1, DE 103 05 704 B3, DE 10 2008 60 004 A1, and DE 10 2020 120 817 A1, the entire disclosures of which are hereby incorporated by reference.

Safety gate monitoring modules of the type in question are used on safety gates, safety flaps and the like. Although the terms “safety gate monitoring module” and “safety gate” are used in the present case, the safety gate monitoring module according to the disclosure can be used on any type of separating protective device. The term “safety gate” in the present sense should accordingly be interpreted broadly. Instead of the general term “separating protective device”, only the term “safety gate” is therefore used below, without this being intended to restrict the scope of protection.

Safety gates on which the safety gate monitoring module according to the disclosure can be used, for example, typically serve as an access to a safety area in which an automatically operating machine or system is located. The machine can be, for example, a robot, a machine tool with a fast-rotating spindle, a transport or conveying system, a press or some other machine or system whose operation poses a risk to persons who are in the aforementioned safety area or in the working area of the machine. The safety gate monitoring module can serve as a signaling device, with the aid of which a control unit can detect the closed state of the safety gate. The control unit is configured to receive the safety gate signal generated by the safety gate monitoring module and to control the machine in accordance with the safety gate signal. For example, the machine can only be operated if the safety gate signal is present. In other words, the control unit is configured to allow operation of the machine or system only if it receives the safety gate signal from the safety gate monitoring module, i.e. if the safety gate is closed. If, on the other hand, the safety gate is opened during operation (if possible), the control unit must bring the machine or system into a safe state in which, for example, the power supply to the machine or system is switched off.

There are a large number of machines and systems that still pose a risk for a certain period of time even after they have been switched off, for example because the machine or system is still running down. For such applications, there is a need for safety gate monitoring modules which prevent the safety gate from opening until the machine or system has reached its safe state. This function is referred to as a guard lock function.

Traditionally, safety gate monitoring modules of the present type have what is referred to as an actuator and an actuator receptacle functioning as a counterpart thereto. The actuator receptacle is part of a base unit, in which further electronic components are typically accommodated and from which the connecting cables that connect the safety gate monitoring module to the control unit usually originate. Accordingly, the base unit with the actuator receptacle is arranged on an immovable part of the safety gate (e.g. on a gate frame), while the actuator is arranged on a movable part of the safety gate (e.g. on a movable gate leaf). This has the advantage that the part of the safety gate monitoring module that is arranged on the movable part of the safety gate does not need to be supplied with power since, as a rule, only the base unit of the safety gate monitoring module has to be supplied with power.

When the safety gate is closed, the actuator engages in the actuator receptacle, this being detected with the aid of one or more sensors. In the case of a safety gate monitoring module with a guard lock system, the actuator is also blocked or locked in the actuator receptacle against retraction. The “guard lock system” comprises a locking device for locking the actuator in the actuator receptacle.

In the latter case, the safety gate monitoring module thus performs two functions, namely on the one hand a detection function, with the aid of which the closed position of the safety gate is detected, and on the other hand a guard lock function, which prevents the safety gate from opening as long as the actuator is locked in the actuator receptacle. The actuator can be released, for example, by using an electric-motor actuator, which is actuated by the control unit as soon as the monitored machine or system has assumed its safe state.

A safety gate monitoring module of this type is marketed by the applicant under the name PSENmlock. This safety gate monitoring module is very versatile. The actuator of the safety gate monitoring module can be substantially rod- or pin-shaped, and the actuator receptacle acting as a counterpart thereto comprises a through-slot, a U-shaped opening or a blind or through-hole, in which the rod- or pin-shaped actuator engages.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

It has been found that repeated closing and opening processes of the safety gates lead to material wear on the actuator and the guard lock device or actuator receptacle after use as intended. This wear can make it impossible to achieve the required service life of the safety gate monitoring module with a specified number of closing and opening processes. Moreover, this can give rise to a safety risk since the guard lock function can no longer be guaranteed with sufficient reliability.

It is an object to provide a safety gate monitoring module which has a longer service life and/or improved reliability.

According to a first aspect, a safety gate monitoring module for monitoring a state of a safety gate is presented, wherein the safety gate monitoring module comprises an actuator receptacle that is configured to receive an actuator and to produce a safety gate signal when the actuator is received in the actuator receptacle, wherein the actuator receptacle comprises a guard lock device that is configured to lock the actuator in the actuator receptacle in an activated state, wherein the guard lock device comprises a bolt having a bearing element receptacle and a bearing element rotatably mounted in the bearing element receptacle and arranged at a free end of the bolt, wherein the free end of the bolt engages with the actuator in order to lock the actuator in the actuator receptacle in the activated state.

According to a second aspect, a safety gate monitoring system is presented, wherein the safety gate monitoring system comprises a safety gate defining an access to a safety area, a safety gate monitoring module for monitoring a state of the safety gate, an actuator, and a control unit configured to receive the safety gate signal and to control a machine or system located in the safety area in accordance with the safety gate signal, wherein the safety gate monitoring module comprises an actuator receptacle that is configured to receive an actuator and to produce a safety gate signal when the actuator is received in the actuator receptacle, wherein the actuator receptacle comprises a guard lock device that is configured to lock the actuator in the actuator receptacle in an activated state, wherein the guard lock device comprises a bolt having a bearing element receptacle and a bearing element rotatably mounted in the bearing element receptacle and arranged at a free end of the bolt, wherein the free end of the bolt engages with the actuator in order to lock the actuator in the actuator receptacle in the activated state.

The guard lock device comprises, in particular, a bearing element which is rotatably mounted in the bolt and is arranged in such a way that the bearing element can be in contact with the actuator. In contrast to conventional guard lock devices, in which a bolt slides on an actuator, it is possible according to the present disclosure for the bearing element mounted in the bolt to roll on the actuator. The presented safety gate monitoring module thus makes it possible advantageously to reduce friction and/or wear in the friction contact between the guard lock device and the actuator and thus also to minimize closing and opening forces in the safety gate monitoring module.

As the actuator is inserted into the actuator receptacle, the bearing element can be in contact with the actuator in order to simplify the insertion of the actuator into the actuator receptacle and/or to reduce friction and/or wear between the guard lock device and the actuator. If the bearing element rolls on the actuator during the insertion of the actuator into the actuator receptacle instead of sliding on the actuator, the friction contact is predominantly characterized by rolling friction instead of sliding friction. Thus, the friction in the friction contact can be reduced. The same applies to the opening process for the safety gate, during which the actuator is withdrawn from the actuator receptacle.

Thus, a solution for reducing the wear between the guard lock device and the actuator and increasing the reliability of the guard lock device is created in a manner that is simple in design and economical.

Moreover, the presented safety gate monitoring module advantageously allows freer and thus more simple configuration of the bolt. The shape of the bolt, in particular, can be configured with greater independence from the actuator. At the same time, the bearing element can be processed independently of the rest of the bolt, e.g. in respect of surface finish, in order to improve the properties of the friction contact. This can have a simplifying effect on the manufacture of the guard lock device and/or of the actuator.

Moreover, the presented safety gate monitoring module makes it possible to exchange the bearing element independently of the rest of the bolt. Even if the guard lock device according to the present disclosure entails reduced wear in comparison with conventional guard lock devices, the bearing element may nevertheless wear with ongoing use. In this case, the presented safety gate monitoring module makes it possible to selectively exchange just the bearing element and to continue using the other parts of the bolt. Thus, the components of the guard lock device can be used on a sustained basis.

To adjust the properties of the friction contact (e.g. friction coefficient between the friction contact partners) as required, the usual procedure is, in particular, to match the materials of the friction contact partners to one another. The presented safety gate monitoring module furthermore makes it possible for the guard lock device to comprise different materials. It is thereby possible to match the materials of the friction contact partners better to one another.

The bearing element can comprise a material which is different from the material of the bolt. It is thus possible to define the properties of the friction contact by using a selected material combination of the bearing element and the actuator, wherein at the same time the selection of the material of the bolt can be more independent of the material of the actuator.

In a refinement, the bolt may comprise a loss prevention element, which is configured to hold the rotatably mounted bearing element captive on the bolt.

By using the loss prevention element, the bearing element is held permanently in the desired position and/or alignment in the bolt. In this way, the reliability of the safety gate monitoring module can be improved.

In a further refinement, the loss prevention element may be formed by using a cross-sectional constriction of the bearing element receptacle.

According to this refinement, the bearing element receptacle is thus constricted in order to hold the bearing element in the desired position and/or alignment in the bolt. The cross-sectional constriction can act as a latching element for the bearing element. This allows simple and economical manufacture of the guard lock device.

In a further refinement, the diameter of the cross-sectional constriction may be smaller than the diameter of the bearing element.

This ensures that the rotatably mounted bearing element cannot be released from the bearing element receptacle. Thus, the bearing element is held securely in the desired position and/or alignment in the bolt.

In a further refinement, the bearing element may comprise a ball.

A ball has the advantage that, by virtue of its symmetry, the ball can be used as a bearing element with a multi-directional action. Thus, the actuator can be inserted into the actuator receptacle from any direction, while the ball, as a bearing element, performs the stated function of friction and wear reduction.

However, the bearing element can also have some other suitable shape, e.g. that of a circular cylinder, which is suitable, in particular, for rotation or rolling on the actuator.

In a further refinement, the bearing element receptacle may comprise a first portion, which is conical, spherical-cup-shaped or cylindrical, and a second portion, which is cylindrical.

The first portion can, in particular, be at least in part in contact with the bearing element and/or act as a receptacle for a bearing insert. The second portion can, in particular, be at least in part in contact with the bearing element and/or act as a casing or housing (in particular to counter the penetration of foreign bodies).

In a further refinement, more than half of the bearing element may be arranged within the bearing element receptacle.

This means, in particular, more than half of the volume of the bearing element. Thus, the majority of the bearing element is protected in the bearing element receptacle. The other part of the bearing element, i.e. less than half (of the volume) of the bearing element, is arranged outside the bearing element receptacle and can be in contact with the actuator.

In a further refinement, the bolt may be preloaded by using a spring.

The spring is configured to activate the guard lock device, such that the guard lock device holds the actuator firmly in the actuator receptacle. The spring engages on an opposite side of the bolt from the free end and can push the bearing element into engagement with the actuator. During the insertion and withdrawal of the bolt into and from the actuator, the bolt can yield counter to the spring force.

In a further refinement, the bolt may comprise a main body and a bearing shell, which is inserted therein and forms at least part of the bearing element receptacle.

The bolt is therefore of at least two- or three-part construction. A bearing shell as a separate component which is inserted into the bolt allows simple production of the bolt.

The bearing element is arranged rotatably in the (inserted) bearing shell. The bearing shell can be configured to receive the bearing element in such a way that the bearing element can roll on the bearing shell. It is thus advantageously possible to make reduced demands on the configuration of the bolt and the configuration of the bearing element receptacle, making it possible to simplify the production of the bolt. In addition, the friction contact can be lubricated.

The bearing element receptacle is of conical design on a side opposite the bearing element.

This advantageously allows relatively simple manufacture of the bearing element receptacle, e.g. by making a hole in the bolt. If the bolt comprises a bearing shell, it is advantageously possible to drill just one hole in order to insert the bearing shell.

In a further refinement, the main body of the bolt may comprise a first material, and the bearing shell comprises a second material, which is different from the first material.

This refinement advantageously makes it possible for the inserted bearing shell to comprise a material which is different from the material of the bolt. Thus, the properties of the friction contact between the bearing element and the bearing shell can be selectively adjusted independently of the material of the bolt (in particular as regards the reduction of friction and wear).

In a further refinement, the bolt may be comprise a sleeve, which is secured on a main body of the bolt and forms at least part of the bearing element receptacle.

In a further refinement, the bearing element receptacle may be of at least two-part configuration, wherein at least part of the bearing element receptacle is formed by the main body of the bolt and the sleeve secured thereon. It is thus advantageously possible to make reduced demands on the main body of the bolt in respect of production, and therefore economical and simple production of the bolt is made possible.

In a further refinement, the sleeve may form at least part of the loss prevention element. In this case, the sleeve forms part of the cross-sectional constriction of the bearing element receptacle. The sleeve can thus act as a latching element for the bearing element.

Thus, further reduced requirements can advantageously be made on the main body of the bolt in respect of the manufacture of the bearing element receptacle, enabling the production of the bolt to be simplified. Moreover, the bearing element can advantageously be pre-installed more easily, thus enabling the sleeve to be used as a loss prevention element for the assembly process, for example.

The sleeve can be secured detachably or non-detachably on the main body of the bolt. In particular, the sleeve can be secured by force- and form-fitting on the main body, e.g. by using a thread, a rivet or a pin. It is likewise or additionally possible for the sleeve to be connected materially to the main body, in particular adhesively bonded, brazed and/or welded. It is also possible, for example, for the sleeve to be shrunk onto the main body. A sleeve secured detachably on the main body can have an advantageous effect inasmuch as the bearing element can be exchanged easily—for example after a certain number of closing and opening processes of the actuator and/or a predetermined wear limit have/has been exceeded.

In a further refinement, the bolt may comprise a multiplicity of bearing balls, which are arranged in the bearing element receptacle.

The bearing element and the bearing balls can be configured to be in contact with one another and to roll on one another. The bearing balls can advantageously comprise a material which is different from the material of the bolt. The properties of the friction contact between the bearing element and the bearing balls can thereby be selectively adjusted, in particular more easily, independently of the bolt (in particular as regards the reduction of friction and wear).

The bearing balls each have a diameter which is smaller than the diameter of the bearing element. The bearing balls each have the same diameter.

As a material, the actuator comprises at least in part (in particular in the contact region with the guard lock device in the activated state of the guard lock device) a chromium-nickel-molybdenum-stainless steel alloy and/or the bearing element comprises a rolling bearing steel and/or the bolt comprises a free-cutting steel or a case-hardening steel.

As already mentioned above, a further aspect relates to a safety gate monitoring system which comprises a safety gate of the abovementioned type (with a safety gate monitoring module), an actuator and a control unit.

The first part of the safety gate, on which the base unit is arranged, is a stationary part of the safety gate (e.g. a gate frame or a gate case). Equivalently to this, the second part of the safety gate, on which the actuator is arranged, is a movable gate element (e.g. a gate leaf). The arrangement of the base unit on the stationary part of the safety gate has the advantage that a power supply of the part of the safety gate monitoring module mounted on the movable part of the safety gate can be omitted since typically only the base unit of the safety gate monitoring module has to be supplied with power.

The actuator comprises a receptacle which is configured to receive the guard lock device in the activated state. The receptacle of the actuator is configured to be in contact with the bearing element. The receptacle of the actuator therefore has a mating shape corresponding to the shape of the bearing element, in particular a conical, spherical-cup-shaped or cylindrical mating shape.

It is to be understood that the features mentioned above and those to be explained below can be used not only in the combination indicated in each case, but also in other combinations or on their own, without departing from the scope of the present disclosure.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 shows a schematic illustration of a safety gate monitoring system according to an embodiment.

FIG. 2 shows a perspective view of a safety gate monitoring module having an actuator according to an embodiment.

FIG. 3A shows a front view of the safety gate monitoring module shown in FIG. 2 with the actuator.

FIG. 3B shows a sectional view of the safety gate monitoring module shown in FIG. 2 with an actuator.

FIG. 4 shows a perspective view of the actuator according to an embodiment.

FIG. 5 shows a sectional view of a bolt according to a first embodiment, which is used in the safety gate monitoring module.

FIG. 6 shows a sectional view intended to provide a schematic illustration of a production step for the production of the bolt shown in FIG. 5.

FIG. 7 shows a sectional view of the bolt according to a second embodiment.

FIG. 8 shows a sectional view of the bolt according to a third embodiment.

FIG. 9 shows a sectional view of the bolt according to a fourth embodiment.

FIG. 10 shows a sectional view of the bolt according to a fifth embodiment.

FIG. 11A shows a sectional view of the bolt according to a sixth embodiment.

FIG. 11B shows a first exploded view of the bolt shown in FIG. 11A.

FIG. 11C shows a second exploded view of the bolt shown in FIG. 11A.

FIG. 12 shows an exploded view of the bolt according to a seventh embodiment.

FIG. 13 shows a perspective view of the bolt according to an eighth embodiment.

FIG. 14 shows a perspective view of the bolt according to a ninth embodiment.

FIG. 15 shows a perspective view of the bolt according to a tenth embodiment.

In the drawings, reference numbers may be reused to identify similar and/or identical elements.

### DETAILED DESCRIPTION

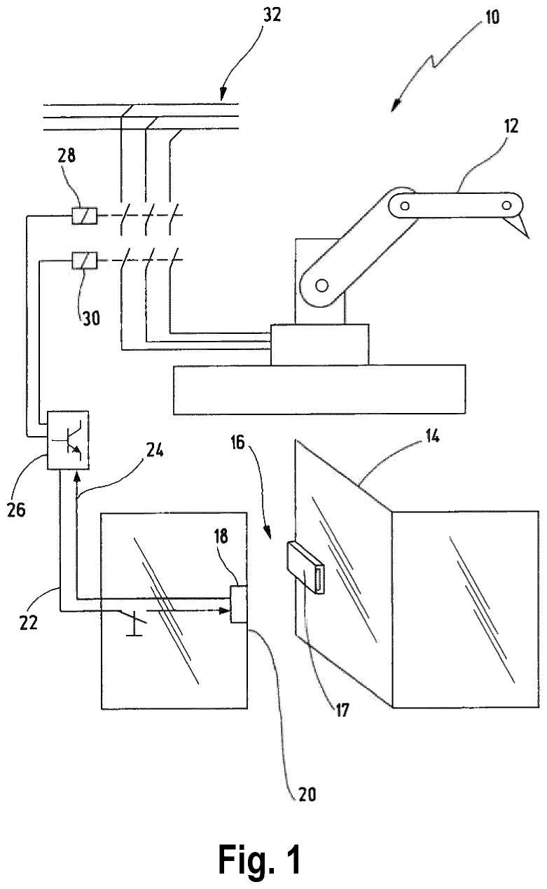

FIG. 1 shows a schematic view of an embodiment of a safety gate monitoring system. In the figure, the safety gate monitoring system is designated overall by the reference numeral 10.

Here, the safety gate monitoring system 10 includes a robot 12, the working area of which is safeguarded with the aid of a safety gate 14. A safety gate monitoring module 16 is arranged on the safety gate 14.

The safety gate monitoring module 16 comprises a gate part 17, which is arranged on the movable gate element (gate leaf) of the safety gate 14, and a frame part 18, which is arranged on an immovable second part 20 of the safety gate 14. In the embodiment illustrated, the immovable second part 20 of the safety gate 14 is a gate frame or a gate case. In other embodiments, this second immovable part 20 of the safety gate 14 can also be a second gate leaf of a two-part safety gate.

The frame part 18 of the safety gate monitoring module 16 is connected to a safety switching device 26 via two lines 22, 24. The safety switching device 26 is, for example, a safety switching device from the PNOZ<®> series, which is marketed by the applicant. This is a multichannel redundant safety switching device, which is configured to evaluate the output signals of signaling devices, such as the safety gate monitoring module 16, and to switch off an electrical load in accordance therewith. In this case, the electrical load is the robot 12. Accordingly, the safety switching device 26 actuates two contactors 28, 30, the make contacts of which are arranged in the connection between a power supply 32 and the robot 12.

As an alternative to the safety switching device 26, the safety gate monitoring module 16 could also be connected to a programmable safety controller, such as that marketed by the applicant under the designation PSS<®>. The safety switching device 26 is therefore generally referred to below as the control unit 26 of the safety gate monitoring system 10, without thereby being limited to a specific embodiment of this control unit. A number of embodiments of the safety gate monitoring module 16 are described below. Here, identical or equivalent components are denoted by the same reference signs.

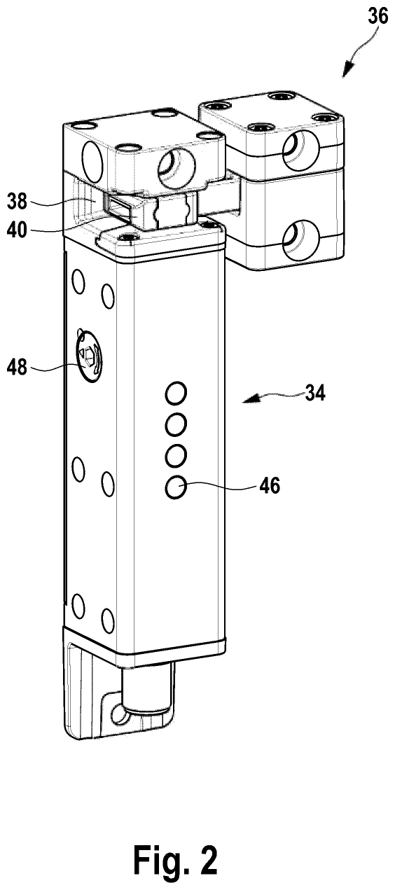

FIG. 2 shows a perspective view of the safety gate monitoring module 16 having a base unit 34 and an actuator 36, which interacts with the base unit 34. The base unit 34 comprises one or more sensors and/or further electronic components and is therefore connected to a power supply. Furthermore, the base unit 34 is connected to the control unit 26 via lines with multi-channel redundancy, such as the lines 22, 24 here. The base unit 34 forms the abovementioned frame part 18 of the safety gate monitoring module 16.

Although it would likewise be conceivable to use the base unit 34 as a gate part 17 of the safety gate monitoring module 16. In such a case, the usually fixed wiring to the control unit 26 and the power supply would have to be routed to the movable part of the safety gate 14, and this is usually more complicated than feeding the lines 22, 24 and the power supply to the static part 20 of the safety gate 14.

The actuator 36 acts as a counterpart to the base unit 34 and serves to actuate the base unit 34. For this purpose, the base unit 34 comprises a corresponding actuator receptacle 38, into which the actuator 36 can be inserted.

One function of the base unit 34 is to detect whether the actuator 36 has been inserted into the actuator receptacle 38 or not. For this purpose, the actuator 36 comprises an RFID chip, which can be read out by a detector arranged in the actuator receptacle 38. The base unit 34 is configured to generate a safety gate signal when the actuator 36 is inserted into the actuator receptacle 38. This safety gate signal is generated as an electrical signal. This can be a digital, a pulsed, a coded and/or other (such as electrical) signal.

By evaluating the safety gate signal in the control unit 26, the safety gate monitoring system 10 can clearly determine at any time whether the safety gate 14 is closed or not. Depending on this, the robot 12 can be controlled in such a way that it can only be operated when the safety gate 14 is closed.

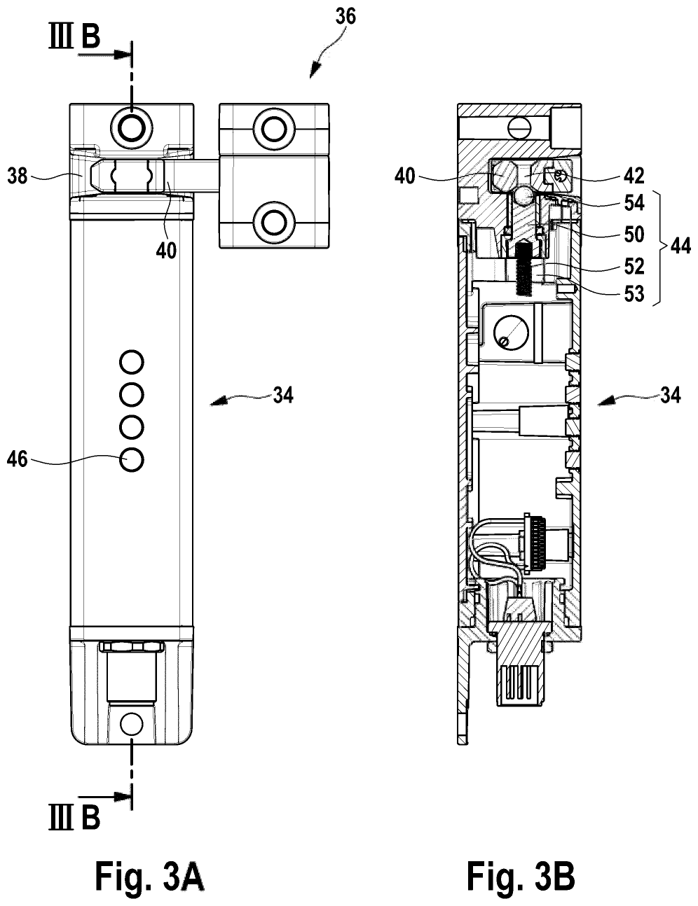

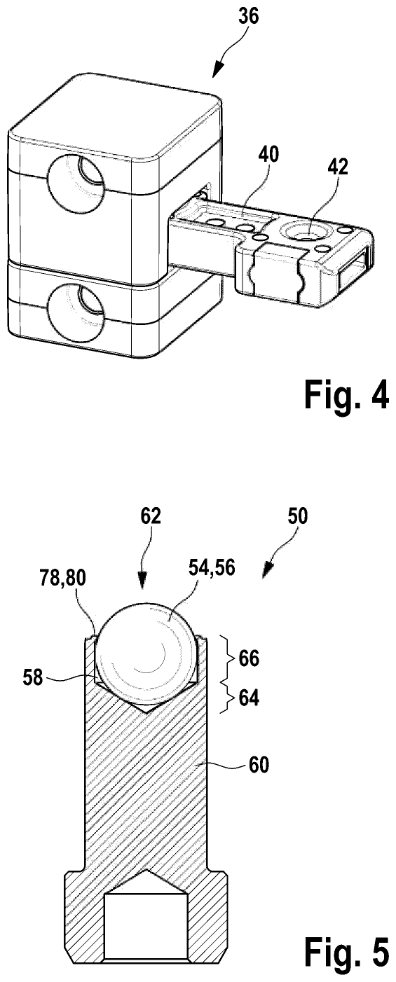

FIGS. 2, 3A and 3B show the actuator element 40 inserted into the actuator receptacle 38 in the closed state of the safety gate 14. In the embodiment shown in FIGS. 2-4, the actuator 36 comprises a substantially rod/pin-shaped actuator element 40, which can be inserted into the actuator receptacle 38. On its end face inserted into the actuator receptacle 38, the actuator element 40 comprises a through-hole 42 (see FIG. 3B) designed as a locating hole, into which a guard lock device 44 engages in order to hold the actuator 36 in the actuator receptacle 38 in the activated state of the guard lock function.

The base unit 34 furthermore comprises one or more optical monitoring indicators 46, which indicate a state of the safety gate monitoring module 16. Furthermore, the base unit 34 comprises an operator control device 48, by means of which a user can change a state of the safety gate monitoring module 16. For example, the operator control device 48 is designed for manual deactivation of the guard lock function of the safety gate monitoring module 16 as an “emergency unlocking function”, by unlocking the guard lock device 44.

The guard lock device 44 comprises a bolt 50, a spring 52 and a locking device 53. The bolt 50 comprises a bearing element 54 rotatably mounted thereon and is preloaded by using the spring 52 and configured to engage in the through-hole 42 in the actuator 36. Owing to the spring preload, the bolt 50 gives way downwards counter to the spring force produced by the spring 52 as the actuator 36 is inserted and withdrawn into and from the actuator receptacle 38. The locking device 53 is configured to lock the bolt 50 in the activated state of the guard lock device 44, as a result of which the actuator 36 is held firmly in the actuator receptacle 38.

The locking of the bolt 50 can be accomplished automatically as a result of a signal (e.g. from the control unit 26 or the safety gate monitoring module 16) or manually by using the operator control device 48. If the safety gate 14 is to be opened again, the actuator 36 must first of all be withdrawn from the actuator receptacle 38 again. For this purpose, the locking device 53 releases the bolt 50 again automatically as a result of a corresponding signal or as a result of manual unlocking by using the operator control device 48.

FIG. 5 shows a first embodiment of the bolt 50, which forms part of the guard lock device 44, in a sectional view. The bolt 50 comprises a bearing element 54 rotatably mounted thereon, which is here designed as a ball 56. The ball 56 is arranged rotatably in a bearing element receptacle 58 formed in the bolt 50, wherein the bearing element receptacle 58 is formed in a main body 60 of the bolt 50. In this case, more than half of the ball volume is arranged in the bearing element receptacle 58.

The ball 56 used as a bearing element 54 is arranged at a free end 62 of the bolt 50, and therefore, when the bolt 50 is inserted into the actuator element 40, the ball 56 is in contact with the actuator element 40 and can roll thereon. The ball 56 can likewise roll on the actuator element 40 when the bolt is withdrawn from the actuator 36.

The bearing element receptacle 58 shown in FIG. 5 comprises a first portion 64 and a second portion 66. The first portion 64 has a conical shape but, in principle, can also be cylindrical, spherical-cup-shaped etc. In the embodiment shown in FIG. 5, the ball 56 can roll in this first portion 64 in the bearing element receptacle 58. The second portion 66 is cylindrical, but may also be cuboidal etc. In the embodiment shown in FIG. 5, the ball 56 is held in position by using the second portion 66, wherein the second portion 66 simultaneously acts as a housing.

The bolt 50 is configured at least in part as a cylindrical body. In the present case, a cylindrical body refers to a body whose cross-sectional area is constant along the longitudinal axis. In particular, the bolt can be a circular cylinder (as shown in FIG. 5, for example), but may also be a cuboidal body or a prism etc.

The bolt 50 furthermore comprises a loss prevention element 78 for holding the ball 56 on the bolt 50. For this purpose, the bearing element receptacle 58 comprises, at the free end 62 of the bolt 50, a cross-sectional constriction 80, which acts as a latching element and thus as a loss prevention element 78 for the ball 56. The cross-sectional constriction 80 is smaller than the diameter of the ball 56.

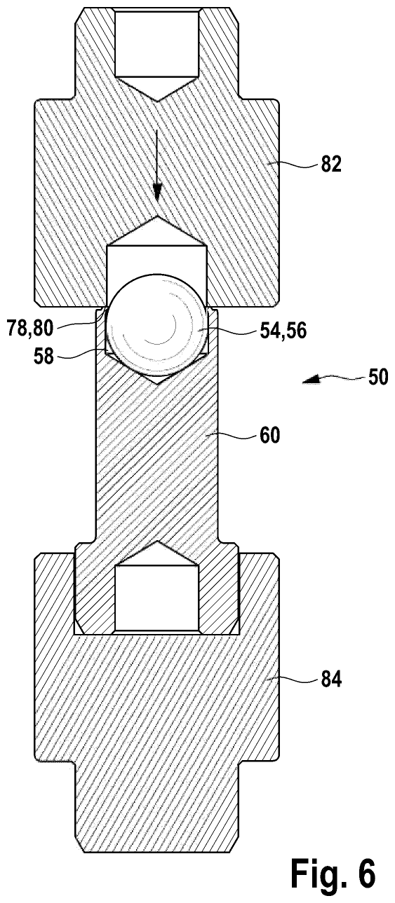

The cross-sectional constriction 80 can be produced by using a stamping process, for example. FIG. 6 schematically shows the stamping process on the bolt 50 shown in FIG. 5. For example, the bolt 50 is designed as a turned part, and the bearing element receptacle 58 is produced by forming a hole. After the insertion of the ball 56 into the bearing element receptacle 58 of the bolt 50, the cross section of the bearing element receptacle 58 is constricted by using a stamping punch 82 and a counter-punch 84. The arrow in FIG. 6 shows the direction in which the stamping punch 82 is pressed against the counter-punch 84. It should be noted here that the stamping process must maintain or not impair the rotatability of the mounted ball 56.

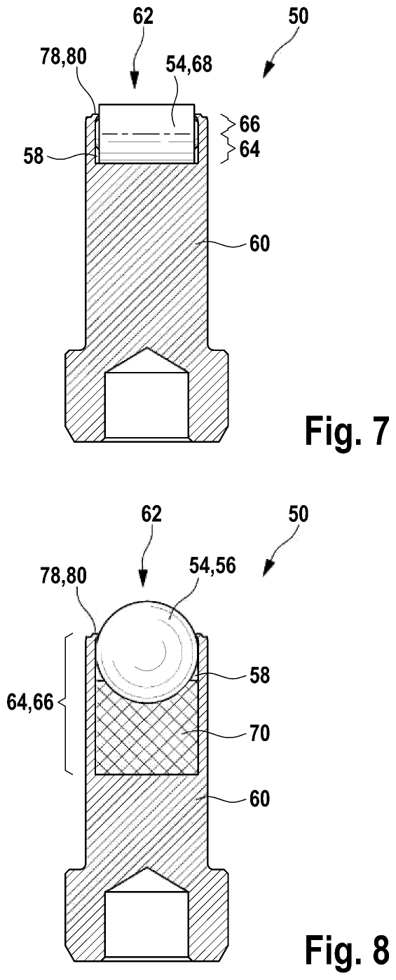

FIG. 7 shows a second embodiment of the bolt 50, in which, in contrast to the bolt 50 shown in FIG. 5, the bearing element 54 is a rotatably mounted circular cylinder 68 (or else a “barrel”, “needle” etc.). Just like the ball 56, the circular cylinder 68 can roll on the actuator 36. However, it will be understood that, in the case where the bearing element 54 is embodied as a barrel or circular cylinder, the actuator 36 can be inserted into the actuator receptacle 38 from only one direction and not from different directions. Such an embodiment could be used in the case of a sliding door, for example.

In the case of the bearing element receptacle 58 shown in FIG. 7, the first portion 64 has a mating shape which corresponds to the circular cylinder 68 and holds the circular cylinder in position. The second portion 66 is cuboidal.

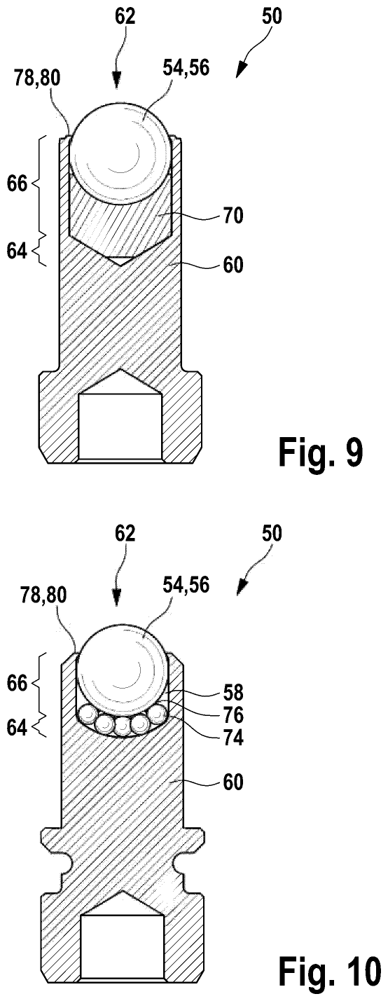

FIG. 8 and FIG. 9 show two further embodiments of the bolt 50, in which a bearing shell 70 is inserted into the main body 60 of the bolt 50 and forms part of the bearing element receptacle 58.

In FIG. 8, the first portion 64 of the bearing element receptacle 58 merges into the second portion 66, or the first portion 64 and the second portion 66 are both cylindrical with the same diameter. In FIG. 9, the first portion 64 is conically shaped, and the second portion 66 is cylindrically shaped. The conically designed first portion 64 can be produced by using a conventional hole. The bearing shells 70 in the embodiments shown in FIGS. 8 and 9 have a mating shape corresponding respectively to the first portion 64 and the second portion 66.

In the embodiments shown in FIGS. 8 and 9, the bearing shell 70 is inserted into the bearing element receptacle 58 of the bolt 50 from the free end 62. The bearing shell 70 and the main body 60 can advantageously be produced separately, allowing simpler production. The material of the main body 60 can be a relatively advantageous free-cutting steel, for example, while the material of the bearing shell 70 can be optimized in respect of wear properties.

FIG. 10 shows another embodiment of the bolt 50. Here, similarly to the embodiment shown in FIG. 5, the bearing element receptacle 58 is formed directly in the main body 60 of the bolt 50. In principle, however, a bearing shell 70 could also be provided here, as above.

A multiplicity of bearing balls 74, on which the ball 56 can roll, is arranged in the bearing element receptacle 58. The bearing balls 74 are arranged in the bearing element receptacle 58 between the ball 56 and the main body 60 of the bolt 50.

The bearing balls 74 have a diameter which is smaller than the diameter of the ball 56. As a result, the ball 56 can simultaneously roll on a multiplicity of bearing balls 74 with a multiplicity of contact points 76. In addition, the bearing balls 74 can adapt as a whole to the contour of the bearing element receptacle 58 (in particular to the first portion 64) and distribute themselves in the bearing element receptacle 58. Here, the first portion 64 of the bearing element receptacle 58 is spherical-cup-shaped in configuration.

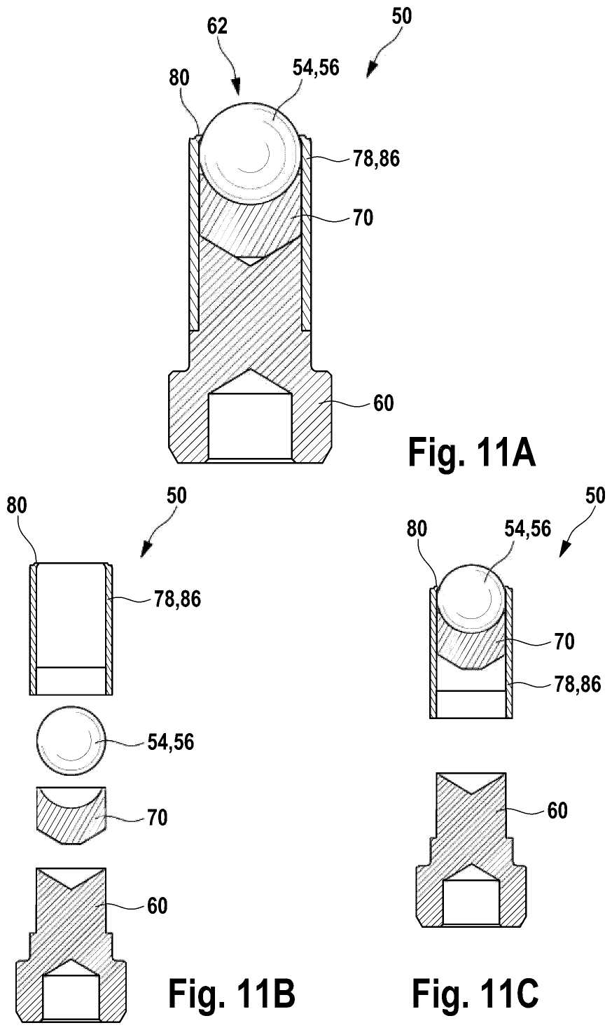

FIG. 11A shows another embodiment of the bolt 50. In contrast to the embodiments shown in FIGS. 5-10, the bolt 50 here comprises an additional sleeve 86, on which the loss prevention element 78 for the ball 56 is formed. The sleeve 86 is arranged on the main body 60 of the bolt 50 and also forms part of the bearing element receptacle 58.

In contrast to the embodiments of the bolt 50 which are shown in FIGS. 5-10, the cross-sectional constriction 80 in FIG. 11A is not formed on the main body 60 but on the sleeve 86. The ball 56 and the bearing shell 70 are inserted into the sleeve 86. The sleeve 86 thus forms a housing for part of the ball 56 and the bearing shell 70. However, it will be understood that, when the bolt 50 is designed with such a sleeve 86, the bearing shell 70, which is here designed as a separate component, does not necessarily have to be provided. Even when the bolt 50 is designed with a sleeve 86, the bearing element receptacle 58 can instead be integrated directly into the main body 60 of the bolt 50, as is the case, for example, with the bolt 50 shown in FIG. 5.

FIGS. 11B and 11C schematically show the assembly of the bolt 50 shown in FIG. 11A. Starting from the state shown in FIG. 11B, first the ball 56 and then the bearing shell 70 are inserted into the sleeve 86 (FIG. 11C). The main body 60 of the bolt 50 is then inserted into the sleeve 86, or the sleeve 86 with the ball 56 and the bearing shell 70 is placed on the main body 60 of the bolt 50 (FIG. 11A). With the sleeve 86, it is possible to omit the stamping process shown in FIG. 6 as a manufacturing step, and therefore the stamping punch 82 (and the counter-punch 84) are not required as separate tools for manufacture, and this has a simplifying effect on assembly.

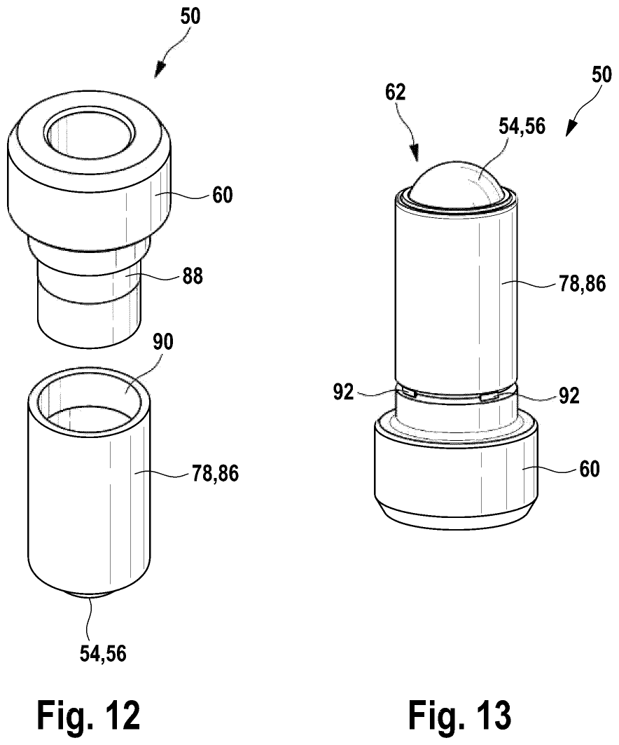

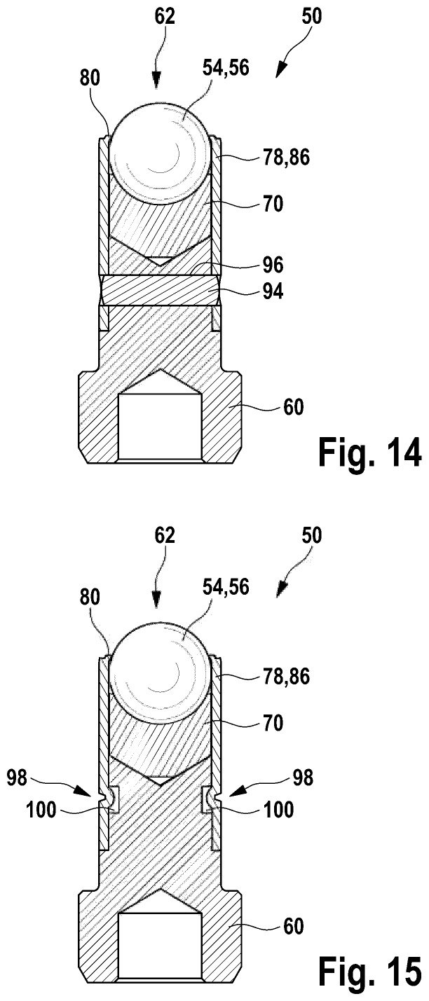

The sleeve 86 can be connected detachably or non-detachably to the main body 60 of the bolt 50. FIGS. 12-15 show various embodiments in this regard. For example, the sleeve 86 can be screwed to the main body 60 of the bolt 50 (FIG. 12) or welded or brazed to it (FIG. 13), or can be secured on the main body 60 by using a pin (FIG. 14) or by stamping (FIG. 15).

FIG. 12 shows the main body 60 with an external thread 88, and the sleeve 86 with a corresponding internal thread 90, which is formed on part of the inner surface of the sleeve 86. The main body 60 of the bolt 50 and the sleeve 86 can thus be screwed detachably to one another. To exchange the ball 56, e.g. after a certain number of closing and opening processes of the guard lock device 44, the sleeve 86 can be unscrewed from the main body 60.

FIG. 13 shows the bolt 50 with the sleeve 86, which is secured on the main body 60 by using a multiplicity of weld seams 92. In this embodiment, the weld seams 92 are distributed uniformly over the circumference of the main body 60 and the sleeve 86.

FIG. 14 shows the bolt 50 with the sleeve 86 and a pin 94, which is arranged in a through-hole 96 in the main body 60 of the bolt 50 and the sleeve 86 and secures the main body 60 to the sleeve 86. The central axes of the through-hole 96 in the main body 60 and the sleeve 86 are in alignment with one another and run substantially orthogonally to the longitudinal axis of the bolt 50.

FIG. 15 shows the bolt 50 with the sleeve 86, wherein the sleeve 86 is secured on the main body 60 by using stamped features 98. The stamped feature 98 is formed by pressing part of the sleeve 86 plastically into the main body 60, thereby connecting the sleeve 86 to the main body 60 by force- and form-fitting. For example, the stamped feature 98 can be introduced by using a center punch. In the embodiment shown in FIG. 15, the main body 60 comprises two recesses 100 (or else sockets), into which part of the sleeve 86 is pressed. The main body 60 of the bolt 50 can likewise have one or more recesses 100 for stamping which are in the form of points, extend continuously around the circumference or extend around part of the circumference. It is likewise also possible for the main body 60 not to have any pre-produced recesses 100, such that part of the sleeve 86 is pressed plastically into the material of the main body 60 by stamping.

It is self-evident that the embodiments shown in the figures show only illustrative embodiments of the safety gate monitoring module, which are intended to illustrate the advantages of the safety gate monitoring module. Various modifications can be made to these embodiments without departing from the scope of the present disclosure.

It is to be understood that the foregoing is a description of one or more various embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A safety gate monitoring module for monitoring a state of a safety gate, the safety gate monitoring module comprising:
an actuator receptacle that is configured to receive an actuator and to produce a safety gate signal in response to the actuator being received in the actuator receptacle, wherein:
the actuator receptacle includes a guard lock device that is configured to lock the actuator in the actuator receptacle in an activated state,
the guard lock device includes a bolt having a bearing element receptacle and a bearing element rotatably mounted in the bearing element receptacle and arranged at a free end of the bolt, and
the free end of the bolt engages with the actuator in order to lock the actuator in the actuator receptacle in the activated state.

2. The safety gate monitoring module of claim 1 wherein the bolt includes a loss prevention element that holds the rotatably mounted bearing element captive on the bolt.

3. The safety gate monitoring module of claim 2 wherein the loss prevention element includes a cross-sectional constriction of the bearing element receptacle.

4. The safety gate monitoring module of claim 3 wherein a diameter of the cross-sectional constriction is smaller than a diameter of the bearing element.

5. The safety gate monitoring module of claim 1 wherein the bearing element includes a ball.

6. The safety gate monitoring module of claim 1 wherein:
the bearing element receptacle includes a first portion and a second portion,
the first portion is at least one of conical, spherical-cup-shaped, or cylindrical, and
the second portion is cylindrical.

7. The safety gate monitoring module of claim 1 wherein more than half of the bearing element is arranged within the bearing element receptacle.

8. The safety gate monitoring module of claim 1 further comprising a spring that acts on the bolt.

9. The safety gate monitoring module of claim 1 wherein:
the bolt includes:
a main body; and
a bearing shell inserted in the main body; and
the bearing shell inserted in the main body forms at least part of the bearing element receptacle.

10. The safety gate monitoring module of claim 9 wherein:
the main body of the bolt includes a first material; and
the bearing shell includes a second material different from the first material.

11. The safety gate monitoring module of claim 1 wherein:
the bolt includes:
a main body; and
a sleeve secured on the main body; and
the sleeve secured on the main body forms at least part of the bearing element receptacle.

12. The safety gate monitoring module of claim 11 wherein the sleeve is screwed, riveted, pinned, stamped and/or materially connected to the main body.

13. The safety gate monitoring module of claim 2 wherein:
the bolt includes:
a main body; and
a sleeve secured on the main body;
the sleeve secured on the main body forms at least part of the bearing element receptacle; and
the sleeve forms at least part of the loss prevention element.

14. The safety gate monitoring module of claim 13 wherein the sleeve is screwed, riveted, pinned, stamped and/or materially connected to the main body.

15. The safety gate monitoring module of claim 1 wherein the bolt includes a plurality of bearing balls arranged in the bearing element receptacle.

16. A safety gate monitoring system comprising:
a safety gate defining an access to a safety area;
a safety gate monitoring module for monitoring a state of the safety gate;
an actuator; and
a control unit configured to receive a safety gate signal and to control a machine or system located in the safety area in accordance with the safety gate signal, wherein:
the safety gate monitoring module includes an actuator receptacle that is configured to receive an actuator and to produce a safety gate signal in response to the actuator being received in the actuator receptacle,
the actuator receptacle includes a guard lock device that is configured to lock the actuator in the actuator receptacle in an activated state,
the guard lock device includes a bolt having a bearing element receptacle and a bearing element rotatably mounted in the bearing element receptacle and arranged at a free end of the bolt, and
the free end of the bolt engages with the actuator in order to lock the actuator in the actuator receptacle in the activated state.

17. The safety gate monitoring system of claim 16 wherein the bolt includes a loss prevention element that holds the rotatably mounted bearing element captive on the bolt.

18. The safety gate monitoring system of claim 17 wherein the loss prevention element includes a cross-sectional constriction of the bearing element receptacle.

19. The safety gate monitoring system of claim 18 wherein a diameter of the cross-sectional constriction is smaller than a diameter of the bearing element.

20. The safety gate monitoring system of claim 17 wherein the bearing element includes a ball.
